(19) United States
(12) Patent Application Publication
(10) Pub. No.: US 2005/0078884 A1
(43) Pub. Date: Apr. 14, 2005

(54) Method and apparatus for interpolating a digital image

(76) Inventor: Jong-hyon Yi, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/933,360

(22) Filed: Sep. 3, 2004

(30) Foreign Application Priority Data
Oct. 13, 2003 (KR) 2003-70985

(51) Int. Cl. G06K 9/32; G06K 9/40

(52) U.S. Cl. 382/300; 382/269

(57) ABSTRACT

A digital image interpolation method and apparatus for correcting a pixel value of an image to thereby minimize a stair-stepping artifact and emphasize a contrast of the edge pixel. The method and apparatus are provided for calculating an interpolation factor and an edge correction operation value. The method and apparatus then perform a first interpolation and a second interpolation using the calculated interpolation factor, and calculate a correction interpolation pixel value for the interpolation location of the magnified image using adjacent pixel values of the adjacent pixels, a first pixel value obtained by the first interpolation edge correction operation value, an edge correction factor for edge correction, and an edge sharpness factor for distinctly representing an edge to enhance image quality in an edge area of a magnified image.

### CROSS-REFERENCE TO RELATED APPLICATIONS

This application claims the benefit under 35 U.S.C. §119(a) of Korean Patent Application No. 2003-70985, filed in the Korean Intellectual Property Office on Oct. 13, 2003, the entire contents of which are incorporated herein by reference.

### BACKGROUND OF THE INVENTION

1. Field of the Invention

The present invention relates to magnification of a digital image. More particularly, the present invention relates to a digital image interpolation method and apparatus which can correct a pixel value of an edge pixel of an image to thereby minimize a stair-stepping artifact and emphasize a contrast of the edge pixel.

2. Description of the Related Art

A conventional digital image interpolation apparatus includes a linear interpolating unit, a quantization processor, an allocation ratio calculator and a pixel value synthesizer. The linear interpolating unit linearly calculates pixel values of a magnified image from an original image. The quantization processor compares a linearly interpolated pixel value with a threshold value to quantize it to a minimum value or a maximum value. The allocation ratio calculator calculates a ratio for mixing the linearly interpolated pixel value with the quantized value. The pixel value synthesizer adds an interpolated pixel value multiplied by the calculated allocation ratio to the quantized value, thereby obtaining a final pixel value.

In order to reduce the blurring effect of a linearly interpolated image and ensure high contrasts of edge pixels in the edge area of the image, a conventional technique has performed an image interpolation as follows. First, a linear interpolation is performed using a plurality of pixel values neighboring a specific location of an original image, corresponding to an interpolation location to be interpolated in a magnified image. Then, a threshold value is obtained using the plurality of pixel values neighboring the specific location of the original image. For example, an average between a maximum value and a minimum value of the plurality of pixel values is selected as the threshold value. Next, if an interpolated value is greater than the threshold value, a maximum value from among the plurality of pixel values neighboring the specific location is selected, and if the interpolated value is equal to or smaller than the threshold value, a minimum value from among the plurality of pixel values is selected.

An allocation ratio is then calculated using a difference between the selected maximum value and minimum value. For example, the allocation ratio is calculated using a linear function which has a value of “0” if the difference between the maximum value and the minimum value is “0”, and the linear function has a value of “1” if the difference between the maximum value and the minimum value is “255”. The calculated allocation ratio is multiplied by the interpolated pixel value and also multiplied by the selected maximum or minimum value. Then, both the multiplied values are summed to obtain an image interpolated pixel value.

The conventional digital image magnification (that is, interpolation) technique can obtain a vivid contrast in an edge of an image, however, a stair-stepping artifact can be generated such that the figure of the edge does not appear in a linear or curved form when the image is shown at a high magnification.

Also, an image magnified by the conventional digital image magnification technique cannot perform an emphasis of edge areas of an image such as unsharp masking, simultaneously with a magnification of the image. That is, the conventional technique emphasizes the edge areas of an image through the unsharp masking after magnifying the image, or magnifies an image after emphasizing the edge areas of the image through the unsharp masking. Therefore, problems exist wherein the unsharp masking for the magnified image cannot obtain a high contrast for emphasizing the edge areas, and the stair-stepping artifact is seen in the edge areas of the image magnified after the unsharp masking.

Accordingly, a need exists for a system and method to minimize a stair-stepping artifact and emphasize a contrast of the edge pixel avoiding the difficulties described above.

### SUMMARY OF THE INVENTION

The present invention provides a digital image interpolation method which enhances image quality in an edge area of an image using adjacent pixel values neighboring a corresponding location of an original image, corresponding to an interpolation location to be interpolated in a magnified image, and further emphasizes an edge of an image while magnifying the image.

The present invention also provides a digital image interpolation apparatus which enhances image quality in an edge area of an image using adjacent pixel values neighboring a corresponding location of an original image, corresponding to an interpolation location to be interpolated in a magnified image, and further emphasizes an edge of an image while magnifying the image.

According to an object of the present invention, a digital image interpolation method is provided comprising the following steps. A first step is provided for calculating an interpolation factor using distances between adjacent pixels neighboring a corresponding location of the original image, corresponding to an interpolation location to be interpolated in the magnified image, and the corresponding location, and calculating an edge correction operation value using a distance and a direction between a specific adjacent pixel nearest to the corresponding location and the corresponding location. A next step is provided for performing a first interpolation and a second interpolation using the calculated interpolation factor, and calculating a correction interpolation pixel value for the interpolation location of the magnified image using adjacent pixel values of the adjacent pixels, a first pixel value obtained by the first interpolation edge correction operation value, an edge correction factor for edge correction, and an edge sharpness factor for distinctly representing an edge.

According to another object of the present invention, a digital image interpolation apparatus is provided comprising an interpolation corresponding location controller for calculating an interpolation factor using distances between a corresponding location of the original image, corresponding to an interpolation location to be interpolated in the magnified image, and adjacent pixels neighboring the corresponding location. The interpolation corresponding location controller being further provided for calculating an edge correction operation value using a distance and a direction between the corresponding location and a specific adjacent pixel nearest to the corresponding location. The digital image interpolation apparatus further comprises a first interpolation unit for performing a first interpolation using the calculated interpolation factor, a second interpolation unit for performing a second interpolation using the calculated interpolation factor, and a correction pixel value detector for calculating a correction interpolation pixel value for the interpolation location of the magnified image using adjacent pixel values of the adjacent pixels, a first pixel value obtained by the first interpolation unit, the edge correction operation value, an edge correction factor for edge correction, and an edge sharpness factor for distinctly representing an edge.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a digital image interpolation method according to an embodiment of the present invention;

FIG. 2 is a flowchart illustrating step 10 shown in FIG. 1, according to an embodiment of the present invention;

FIG. 3 illustrates an example showing the corresponding location of an original image, corresponding to an interpolation location to be interpolated in a magnified image;

FIG. 4 is a flowchart illustrating step 16 shown in FIG. 1, according to an embodiment of the present invention;

FIG. 5 is a flowchart illustrating step 52 shown in FIG. 4, according to an embodiment of the present invention;

FIG. 6 is a block diagram of a digital image interpolation apparatus according to an embodiment of the present invention;

FIG. 7 is a block diagram of a correction interpolation request sensor 100 shown in FIG. 6, according to an embodiment of the present invention;

FIG. 8 is a block diagram of a correction pixel value detector 140 shown in FIG. 6, according to an embodiment of the present invention; and

FIG. 9 is a block diagram of a threshold value decision unit 310 shown in FIG. 8, according to an embodiment of the present invention.

Throughout the drawings, like reference numerals will be understood to refer to like parts, components and structures.

### DETAILED DESCRIPTION OF THE EXEMPLARY EMBODIMENTS

Hereinafter, a digital image interpolation method according to the present invention will be described in detail with reference to the appended drawings.

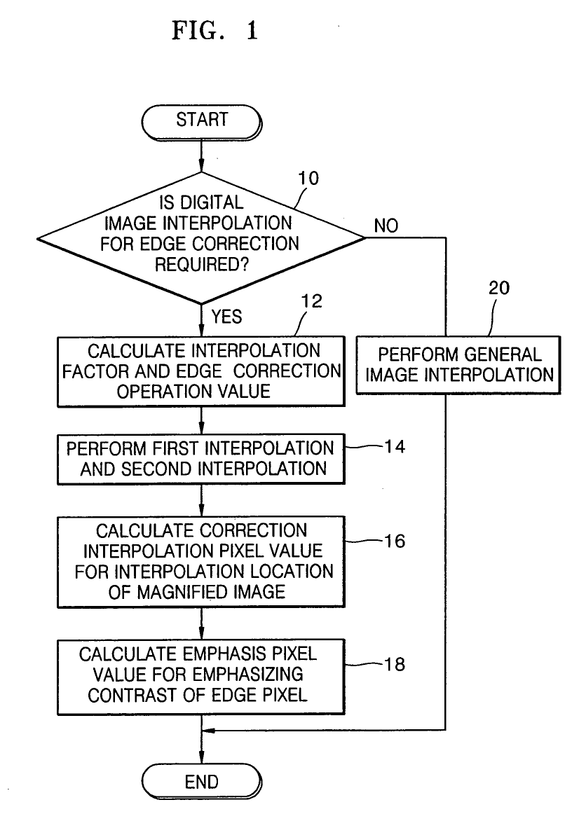

FIG. 1 is a flowchart illustrating a digital image interpolation method according to an embodiment of the present invention, wherein the digital image interpolation method includes steps 10 through 20 that determine whether digital image interpolation for edge correction is required, and obtain a correction interpolation pixel value and an emphasis pixel value.

It is first determined in step 10 whether digital image interpolation for edge correction is required. That is, it is determined whether high quality image interpolation for an edge area of a magnified image is required.

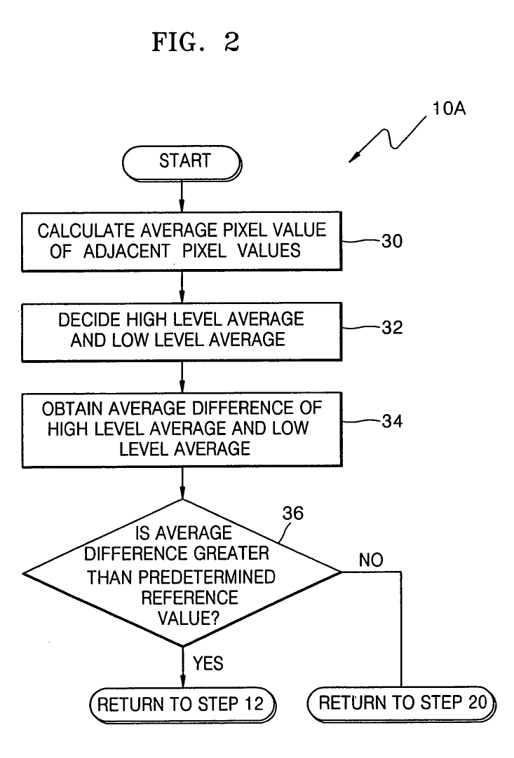

FIG. 2 is a flowchart 10A illustrating step 10 shown in FIG. 1 in greater detail, according to an embodiment of the present invention, wherein the embodiment includes steps 30 through 36 that obtain a difference between a high level average and a low level average of adjacent pixel values, and determine whether digital image interpolation for edge correction is required.

In a first step 30 of FIG. 2, an average pixel value for pixel values of adjacent pixels neighboring a corresponding location of an original image, corresponding to a location to be interpolated in a magnified image, is calculated. If a location to be interpolated in an image magnified from an original image cannot have a pixel value of the corresponding location of the original image, it is necessary to obtain a pixel value of the interpolation location of the magnified image using pixel values of adjacent pixels neighboring the corresponding location of the original image, corresponding to the interpolation location of the magnified image.

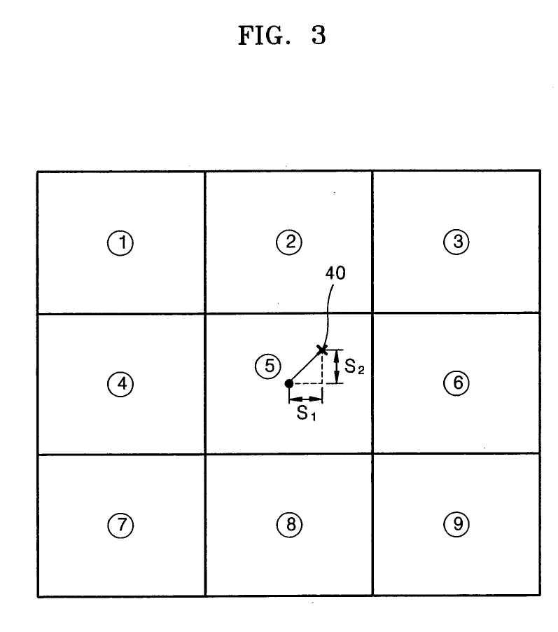

FIG. 3 illustrates an example showing the corresponding location of the original image, corresponding to the interpolation location of the magnified image. A corresponding location of the original image, corresponding to the interpolation location of the magnified image, is denoted by a reference number “40” in FIG. 3. FIG. 3 further shows nine adjacent pixels 1 through 9 neighboring the corresponding location 40. Four or sixteen adjacent pixels can be taken as necessary. An average value of pixel values of the nine adjacent pixels 1 through 9 is obtained in step 30.

After step 30, the adjacent pixel values are classified into two groups according to the average pixel value, and then averages of pixels in each of the groups are obtained as a high level average and a low level average, respectively, in step 32. For example, if an average pixel value of the nine adjacent pixel values shown in FIG. 3 is a gray-scale value of ‘130’,an average of the adjacent pixel values higher than the gray-scale value of 130 is obtained as the high level average, and an average of the adjacent pixel values lower than the gray-scale value of 130 is obtained as the low level average.

After step 32, a difference between the high level average and the low level average is calculated in step 34. For example, if the high level average is ‘170’ and the low level average is ‘90’,an average difference value of 80 is obtained by subtracting 90 from 170.

After step 34, it is then determined in step 36 whether the average difference value is greater than a predetermined reference value. The predetermined reference value is provided for determining whether or not the difference between the high level average and the low level average exceeds a predetermined value. A large difference between the high level average and the low level average indicates a high probability that an edge area, in which adjacent pixels are greatly different in their pixel values, exists in an original image. Accordingly, when the average difference value exceeds the predetermined reference value, it is determined that digital image interpolation for edge correction is required, and correspondingly, predetermined steps as described in greater detail below, are then performed in order to obtain a high-quality magnified image.

For example, if an average difference value is ‘80’ and a predetermined reference value is ‘50’,the average difference value is greater than the predetermined reference value and there exists a high probability that an edge area (in which adjacent pixels are greatly different in their pixel values) is formed in a corresponding original image. Accordingly, after step 36, the process proceeds to step 12 of FIG. 1. However, if the average difference value is smaller than the predetermined reference example value of ‘50’,there exists a low probability that an edge area is formed in the original image, and after step 36 the process proceeds to step 20 of FIG. 1.

Returning to FIG. 1, after step 10, if it is determined that the digital image interpolation for edge correction is required, an interpolation factor is calculated using distances between adjacent pixels neighboring the corresponding location of the original image and the corresponding location, and an edge correction operation value is calculated using a distance and a direction between a specific adjacent pixel nearest to the corresponding location and the corresponding location in step 12. For example, as shown in FIG. 3, respective distances between nine adjacent pixels, neighboring the corresponding location 40 of the original image, and the corresponding location 40 are obtained, and the interpolation factor is calculated using the obtained distances. The edge correction operation value is calculated using a distance and a direction between the corresponding location 40 and a specific adjacent pixel 5, pixel 5 being an adjacent pixel nearest to the corresponding location 40. The edge correction operation value is a pair of values consisting of a horizontal distance S1 and a vertical distance S2 to the specific adjacent pixel 5 from the corresponding location 40.

After step 12, a first interpolation and a second interpolation are performed using the calculated interpolation factor in step 14. The first interpolation is performed using a high order (secondary or more) interpolation kernel or a spline kernel. The interpolation using the high order interpolation kernel is provided to perform image interpolation using 16 adjacent pixel values neighboring a corresponding location by a high order function that is not a linear function. The interpolation using the spline kernel is provided to perform image interpolation by a spline function. The second interpolation can use a linear interpolation kernel. The second interpolation is, for example, an interpolation method that calculates a pixel value using a sum of weight values of four adjacent pixel values adjacent to a corresponding location.

After step 14, a correction interpolation pixel value for the interpolation location of the magnified image is calculated using the adjacent pixel values of the adjacent pixels, the edge correction operation value, a first pixel value obtained by the first, interpolation, an edge correction factor for edge correction and an edge sharpness factor for emphasizing an edge in step 16. The edge correction factor is a predetermined factor for correcting the edge area of the original image. The edge sharpness factor is a predetermined factor for distinctly representing the edge area of the original image. The correction interpolation pixel value describes an optimal pixel value for the interpolation location of the magnified image.

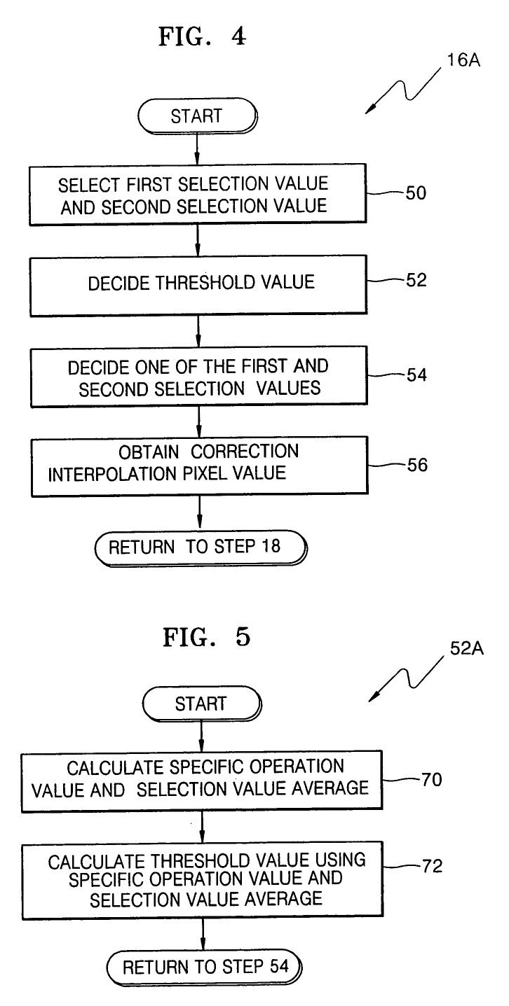

FIG. 4 is a flowchart 16A illustrating step 16 shown in FIG. 1 in greater detail, according to an embodiment of the present invention, wherein the embodiment includes steps 50 through 56 that compare the first pixel value with a threshold value, and obtain a correction interpolation pixel value using a value selected through the comparison.

In step 50, first and second selection values are selected from among the adjacent pixel values. Specifically, a greatest pixel value from among the adjacent pixel values can be selected as a first selection value, and a smallest pixel value from among the adjacent pixel values can be selected as a second value. Alternately, it is possible to group the adjacent pixel values into predetermined groups, obtain average values of the pixel values in each of the groups respectively, and then select a greatest value of the obtained average values as a first selection value, and a smallest value of the obtained average values as a second selection value.

After step 50, a threshold value to be compared with the first pixel value is calculated using the specific pixel value of a specific adjacent pixel nearest to the corresponding location, the edge correction operation value, the first and second selection values and the edge correction factor in step 52.

FIG. 5 is a flowchart 52A illustrating step 52 shown in FIG. 4 in greater detail, according to an embodiment of the present invention, wherein the embodiment includes steps 70 and 72 that are provided to calculate the threshold value using a specific operation value and a selection value average.

First, in step 70, a value equal to or smaller than 1 is found from among values created by substituting a horizontal distance and a vertical distance of the edge correction operation value into a denominator and a numerator, and into a numerator and a denominator, respectively, and is selected as a specific operation value. An average between the first selection value and the second selection value is then selected as a selection value average. For example, a value equal to or smaller than 1 is found from among values “S1/S2” and “S2/S1” created by substituting a horizontal distance S1 and a vertical distance S2 shown in FIG. 3 into a denominator and a numerator, and into a numerator and a denominator, respectively, and is selected as the specific operation value. Also, an average between the first and second selection values obtained in step 50 is selected as the selection value average.

After step 70, a threshold value is obtained using the specific operation value and the selection value average in step 72, according to the following equation (1).

Th 32 M+Fc*S*(E−M) (1)

In equation (1), Th is the threshold value, M is the selection value average, Fc is the edge correction factor, S is the specific operation value, and E is the specific adjacent pixel value.

Returning to FIG. 4, after step 52, the first pixel value is compared with the threshold value so that one value of the first and second selection values is selected in step 54. If the first pixel value is greater than the threshold value, the first selection value is selected, and if the first pixel value is equal to or smaller than the threshold value, the second selection value is selected.

After step 54, the chosen selection value is multiplied by a first allocation ratio of the edge sharpness factor, the first pixel value is multiplied by a second allocation ratio of the edge sharpness factor, and both the multiplied values are summed, thereby obtaining a correction interpolation pixel value in step 56. The first and second allocation ratios of the edge sharpness factor are a weight value for the chosen selection value and a weight value for the first pixel value, respectively. The first and second allocation ratios are set, respectively, so that the sum of the first and second allocation ratios equals 1. The first and second allocation ratios of the edge sharpness factor can have fixed values or can be varied as described in greater detail below.

Specifically, a value obtained by dividing a difference between the first pixel value and the specific adjacent pixel value of the specific adjacent pixel nearest to the corresponding location, by the distance between the specific adjacent pixel and the corresponding location, can be set as the first allocation ratio of the edge sharpness factor. That is, the correction interpolation pixel value is obtained by multiplying the chosen selection value and the first pixel value by the first and second allocation ratios (the respective weight values of the chosen selection value and first pixel value) of the edge sharpness factor, respectively, and summing both the multiplied values.

Returning to FIG. 1, after step 16, an emphasis pixel value for emphasizing a contrast of the edge pixel in the edge is obtained using the correction interpolation pixel value, a second pixel value obtained by the second interpolation, and an edge image quality enhancement factor for image quality enhancement in edges in step 18. The edge enhancement factor is a factor for unsharp masking. The emphasis pixel value is a pixel value for emphasizing an edge in the magnified image by unsharp masking.

The emphasis pixel value can be obtained by the following equation (2).

R=Q+Fe*(Q−P) (2)

In equation (2), R is the emphasis pixel value, Q is the correction interpolation pixel value, Fe is the edge image quality enhancement factor, and P is the second pixel value.

Returning to FIG. 1, if it is determined in step 10 that the digital image interpolation for edge correction is not required, general image interpolation is performed in step 20. The general image interpolation describes image interpolation using a conventional technique as known to those skilled in the art and therefore, detailed descriptions thereof are omitted.

Hereinafter, a digital image interpolation apparatus according to the present invention will be described with reference to the appended drawings.

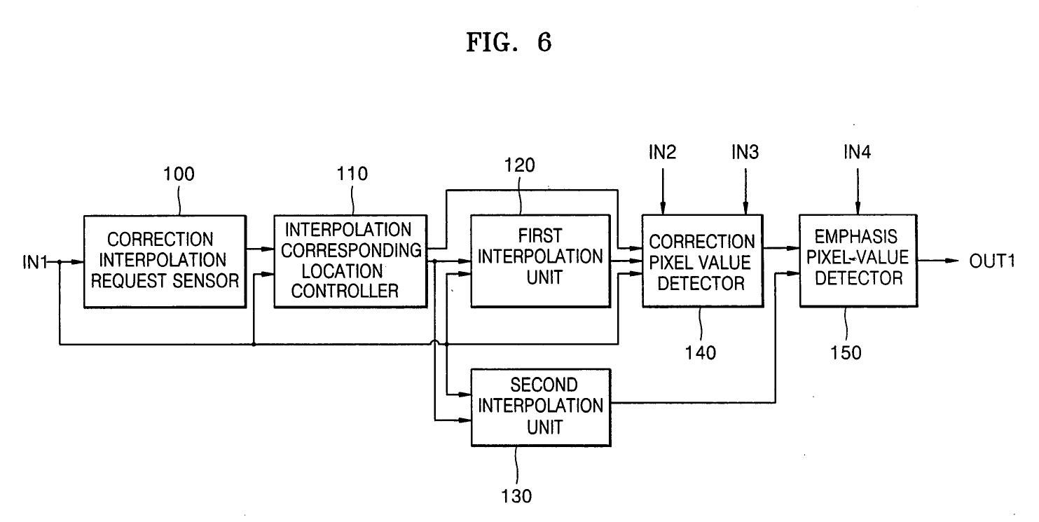

FIG. 6 is a block diagram of a digital image interpolation apparatus according to an embodiment of the present invention, wherein the digital image interpolation apparatus includes a correction interpolation request sensor 100, an interpolation corresponding location controller 110, a first interpolation unit 120, a second interpolation unit 130, a correction, pixel value detector 140, and an emphasis pixel value detector 150.

The correction interpolation request sensor 100 senses whether digital image interpolation for edge correction is required. For example, the correction interpolation request sensor 100 receives adjacent pixel values of adjacent pixels through an input terminal IN1, as shown in FIG. 3, senses whether the digital image interpolation for edge correction is required, and outputs the sensed result to the interpolation corresponding location controller 110.

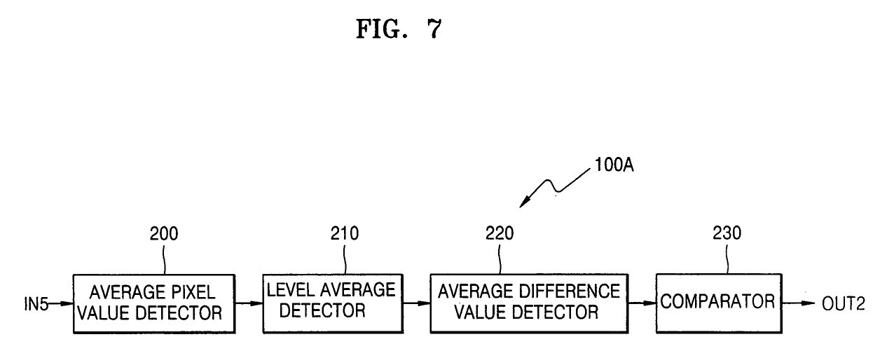

FIG. 7 is a block diagram 1OOA of an embodiment of the correction interpolation request sensor 100 shown in FIG. 6 according to the present invention, wherein the correction interpolation request sensor 100 includes an average pixel value detector 200, a level average detector 210, an average difference value detector 220 and a comparator 230.

The average pixel value detector 200 calculates an average pixel value of the adjacent pixel values. For example, the average pixel value detector 200 receives the adjacent pixel values of the adjacent pixels through an input terminal IN5, calculates an average pixel value of the adjacent pixel values and outputs the calculated average pixel value to the level average detector 210.

The level average detector 210 divides the adjacent pixel values into two groups according to the average pixel value received from the average pixel value detector 200, selects averages of pixels in each of the groups as a high level average and a low level average, respectively, and outputs the selected high level and low level averages to the average difference value detector 220.

The average difference value detector 220 calculates an average difference value between the high level average and low level average received from the level average detector 210 and outputs the calculated average difference value to the comparator 230.

The comparator 230 compares the average difference value received from the average difference value detector 220 with a predetermined reference value and outputs the compared result to the interpolation corresponding location controller 110 through an output terminal OUT2.

Returning to FIG. 6, the interpolation corresponding location controller 110 receives a result sensed by the correction interpolation request sensor 100, calculates an interpolation factor by obtaining distances between the adjacent pixels and the corresponding location using the adjacent pixel values of the adjacent pixels neighboring the corresponding location received through the input terminal IN1, and outputs the calculated interpolation factor to the first interpolation unit 120 and the second interpolation unit 130. Also, the interpolation corresponding location controller 110 calculates an edge correction operation value using a distance and a direction between the corresponding location and the specific adjacent pixel nearest to the corresponding location, and outputs the calculated edge correction operation value to the correction pixel value detector 140. The interpolation corresponding location controller 110 obtains an edge correction operation value consisting of a pair of values of a horizontal distance and a vertical distance to the specific adjacent pixel from the corresponding location.

The first interpolation unit 120 performs a first interpolation using the interpolation factor and outputs a first pixel value created by the first interpolation to the correction pixel value detector 140. The first interpolation unit 120 performs the first interpolation using a high order (secondary or more) interpolation kernel or a spline kernel.

The second interpolation unit 130 performs a second interpolation using the interpolation factor and outputs a second pixel value created by the second interpolation to the emphasis pixel value detector 150. The second interpolation unit 130 performs the second interpolation using a linear interpolation kernel.

The correction pixel value detector 140 calculates a correction interpolation pixel value for an interpolation location of a magnified image using the adjacent pixel values of the adjacent pixels received through the input terminal IN1, the edge correction operation value received from the interpolation corresponding location controller 110, the first pixel value obtained by the first interpolation unit 120, the edge correction factor for edge correction received through the input terminal IN2, and the edge sharpness factor for emphasizing an edge received through the input terminal IN3, and outputs the calculated correction interpolation pixel value to the emphasis pixel value detector 150.

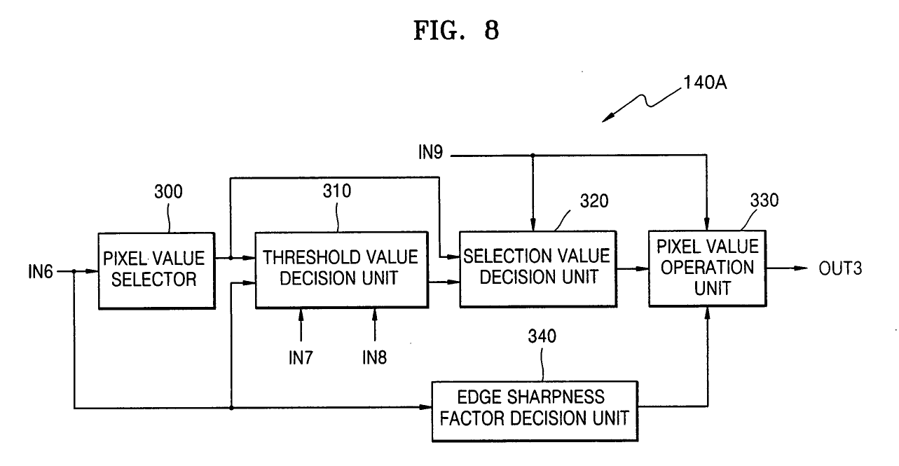

FIG. 8 is a block diagram 140A of an embodiment of the correction pixel value detector 140 shown in FIG. 6 according to the present invention, wherein the correction pixel value detector 140 includes a pixel value selector 300, a threshold value decision unit 310, a selection value decision unit 320, a pixel value operation unit 330, and an edge sharpness factor decision unit 340.

The pixel value selector 300 selects a first selection value and a second selection value from among adjacent pixel values received through an input terminal IN6, and outputs the selected result to the threshold value decision unit 310. Specifically, the pixel value selector 300 selects a greatest value from among the adjacent pixel values as the first selection value, and selects a smallest value from among the adjacent pixel values as the second selection value.

The threshold value decision unit 310 calculates a threshold value to be compared with the first pixel value using the specific adjacent pixel value of the specific adjacent pixel nearest to the corresponding location from among the adjacent pixel values received through the input terminal IN6, an edge correction operation value received through an input terminal IN7, the first and second selection values received from the pixel value selector 300, an edge correction factor received through an input terminal IN8, and then outputs the calculated threshold value to the selection value decision unit 320.

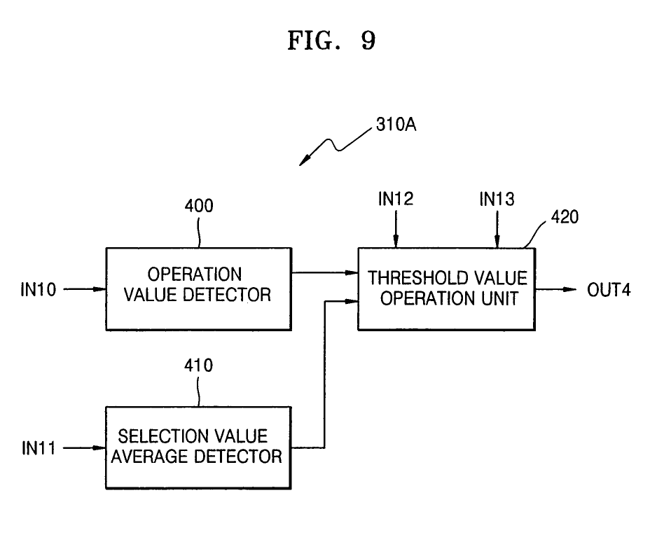

FIG. 9 is a block diagram 310A of an embodiment of the threshold value decision unit 310 shown in FIG. 8 according to the present invention, wherein the threshold value decision unit 310 includes an operation value detector 400, a selection value average detector 410, and a threshold value operation unit 420.

The operation value detector 400 selects as a specific operation value, a value equal to or smaller than 1 from among values created by substituting a horizontal distance and a vertical distance of an edge correction operation value received through an input terminal IN10 into a denominator and a numerator, and into a numerator and a denominator, respectively, and outputs the selected predetermined operation value to the threshold value operation unit 420.

The selection value average detector 410 selects as a selection value average, an average between the first selection value and second selection value received through the input terminal IN11, and outputs the selection value average to the threshold value operation unit 420.

The threshold value operation unit 420 calculates a threshold value by the above equation (1), using the specific operation value received from the operation value detector 400 and the selection value average received from the selection value average detector 410, and outputs the threshold value through an output terminal OUT4.

Returning to FIG. 8, the selection value decision unit 320 compares a first pixel value received through an input terminal IN9 with the threshold value received from the threshold value decision unit 310, selects one of the first selection value and the second selection value received from the pixel value selector 300, and outputs the selected value to the pixel value operation unit 330. The selection value decision unit 320 selects the first selection value if the first pixel value is greater than the threshold value, and selects the second selection value if the first pixel value is equal to or smaller than the threshold value.

The pixel value operation unit 330 multiplies the selection value selected by the selection value decision unit 320 by a first allocation ratio of the edge sharpness factor calculated by the edge sharpness factor decision unit 340, multiplies the first pixel value received through the input terminal IN9 by a second allocation ration of the edge sharpness factor calculated by the edge sharpness factor decision unit 340, sums both the multiplied values to thereby obtain a correction interpolation pixel value, and outputs the obtained correction interpolation pixel value through an output terminal OUT3.

The edge sharpness factor decision unit 340 receives adjacent pixel values through an input terminal IN6, and then selects as the first allocation ratio of the edge sharpness factor, a value obtained by dividing a difference between the first pixel value and a specific adjacent pixel value of a specific adjacent pixel, by the distance between the specific adjacent pixel and the corresponding location, and outputs the selected result to the pixel value operation unit 330.

Returning to FIG. 6, the emphasis pixel value detector 150 then calculates an emphasis pixel value for emphasizing a contrast of an edge pixel using the correction interpolation pixel value detected by the correction pixel value detector 140, the second pixel value obtained by the second interpolation performed by the second interpolation unit 130, and an edge image quality enhancement factor for edge image quality enhancement received through an input terminal IN4, and outputs the calculated emphasis pixel value through the output terminal OUT1.

The emphasis pixel value detector 150 calculates the emphasis pixel value according to the above equation (2).

As described above, the digital image interpolation method and apparatus according to the present invention can enhance image quality in an edge area of a magnified image using pixel values of adjacent pixels neighboring a corresponding location of an original image, corresponding to an interpolation location of the magnified image, such that a stair-stepping artifact is not generated, and to emphasize an edge of an image while magnifying the image without a separate device for emphasizing a contrast of an edge pixel.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A digital image interpolation method which magnifies an original image and creates a magnified image, comprising the steps of:
calculating an interpolation factor using distances between adjacent pixels neighboring a corresponding location of the original image, corresponding to an interpolation location to be interpolated in the magnified image, and the corresponding location;
calculating an edge correction operation value using a distance and a direction between a specific adjacent pixel nearest to the corresponding location and the corresponding location;
performing a first interpolation and a second interpolation using the calculated interpolation factor; and
calculating a correction interpolation pixel value for the interpolation location of the magnified image using adjacent pixel values of the adjacent pixels, a first pixel value obtained by the first interpolation edge correction operation value, an edge correction factor for edge correction, and an edge sharpness factor for distinctly representing an edge.

2. The method of claim 1, wherein in the step of calculating the interpolation factor and the edge correction operation value, the edge correction operation value includes a pair of values comprising a horizontal distance and a vertical distance to the specific adjacent pixel from the corresponding location.

3. The method of claim 2, further comprising the steps of:
performing the first interpolation using a high order interpolation kernel or a spline kernel; and
performing the second interpolation using a linear interpolation kernel.

4. The method of claim 3, wherein the step of calculating the correction interpolation pixel value comprises the steps of:
selecting a first selection value and a second selection value from among the adjacent pixel values;
selecting a threshold value to be compared with the first pixel value using a specific adjacent pixel value of the specific adjacent pixel nearest to the corresponding location, the edge correction operation value, the first and second selection values, and the edge correction factor;
comparing the first pixel value with the threshold value and selecting one of the first and second selection values; and
multiplying the selected value by a first allocation ratio of the edge sharpness factor, multiplying the first pixel value by a second allocation ratio of the edge sharpness factor, and summing both the multiplied values to obtain the correction interpolation pixel value.

5. The method of claim 4, wherein the step of selecting the first selection value and the second selection value comprises the steps of:
selecting a greatest pixel value from among the adjacent pixel values as the first selection value; and
selecting a smallest pixel value from among the adjacent pixel values as the second selection value.

6. The method of claim 5, wherein the step of selecting the threshold value comprises the steps of:
selecting as a specific operation value, a value equal to or smaller than 1 from among values created by substituting the horizontal distance and the vertical distance of the edge correction operation value into a denominator and a numerator, and into a numerator and a denominator, respectively, and obtaining an average of the first selection value and the second selection value as a selection value average; and
obtaining the threshold value using the specific operation value and the selection value average.

7. The method of claim 6, wherein the step of obtaining the threshold value using the specific operation value and the selection value average is performed according to the following equation:
Th=M+Fc*S*(E—M), wherein Th is the threshold value, M is the selection value average, Fc is the edge correction factor, S is the specific operation value and E is the specific adjacent pixel value.

8. The method of claim 6, wherein the steps of comparing the first pixel value with the threshold value and selecting the one of the first and second selection values comprises the steps of:
selecting the first selection value if the first pixel value is greater than the threshold value; and
selecting the second selection value if the first pixel value is equal to or smaller than the threshold value.

9. The method of claim 8, wherein the step of obtaining the correction interpolation pixel value further comprises the step of:
obtaining the first allocation factor of the edge sharpness factor by dividing a difference between the specific adjacent pixel value of the specific adjacent pixel and the first pixel value, by the distance between the specific adjacent pixel and the corresponding location.

10. The method of claim 1, further comprising the step of:
determining whether digital image interpolation for edge correction is required, wherein a process proceeds to the step of calculating the interpolation factor and the edge correction operation value if the digital image interpolation for edge correction is required.

11. The method of claim 10, wherein the step of determining whether the digital image interpolation for edge correction is required comprises the steps of:
calculating an average pixel value of the adjacent pixel values;
dividing the adjacent pixel values into two groups according to the average pixel value, and setting averages of pixel values in each of the groups as a high level average and a low level average;
calculating an average difference between the high level average and the low level average; and
determining whether the average difference is greater than a predetermined reference value, wherein it is determined that the digital image interpolation for edge correction is required if the average difference is greater than the predetermined reference value.

12. The method of claim 1, wherein subsequent to the step of calculating the correction interpolation pixel value, the method further comprises the step of:
calculating an emphasis pixel value for emphasizing a contrast of an edge pixel in an edge of the magnified image using the correction interpolation pixel value, the second pixel value obtained by the second interpolation, and an edge image quality enhancement factor for edge image quality enhancement.

13. The method of claim 12, wherein the emphasis pixel value is calculated by the following equation:
R=Q+Fe*(Q−P),
wherein R is the emphasis pixel value, Q is the correction interpolation pixel value, Fe is the edge image quality enhancement factor, and P is the second pixel value.

14. A digital image interpolation apparatus which magnifies an original image and creates a magnified image, comprising:
an interpolation corresponding location controller for calculating an interpolation factor using distances between a corresponding location of the original image, corresponding to an interpolation location to be interpolated in the magnified image, and adjacent pixels neighboring the corresponding location, and further provided for calculating an edge correction operation value using a distance and a direction between the corresponding location and a specific adjacent pixel nearest to the corresponding location;
a first interpolation unit for performing a first interpolation using the calculated interpolation factor;
a second interpolation unit for performing a second interpolation using the calculated interpolation factor;
a correction pixel value detector for calculating a correction interpolation pixel value for the interpolation location of the magnified image using adjacent pixel values of the adjacent pixels, a first pixel value obtained by the first interpolation unit, the edge correction operation value, an edge correction factor for edge correction, and an edge sharpness factor for distinctly representing an edge.

15. The apparatus of claim 14, wherein the interpolation corresponding location controller calculates an edge correction operation value having a pair of values comprising a horizontal distance and a vertical distance to the specific adjacent pixel from the corresponding location.

16. The apparatus of claim 15, wherein the first interpolation unit performs the first interpolation using a high order interpolation kernel or a spline kernel.

17. The apparatus of claim 16, wherein the second interpolation unit performs the second interpolation using a linear interpolation kernel.

18. The apparatus of claim 17, wherein the correction pixel value detector comprises:
a pixel value selection unit for selecting a first selection value and a second pixel value from among the adjacent pixel values;
a threshold value decision unit for selecting a threshold value to be compared with the first pixel value using a specific adjacent pixel value of the specific adjacent pixel nearest to the corresponding location, the edge correction operation value, the first and second selection values, and the edge correction factor;
a selection value decision unit for comparing the first pixel value with the threshold value and for selecting one of the first and second selection values; and
a pixel value operation unit for multiplying the selected value by a first allocation ratio of the edge sharpness factor, for multiplying the first pixel value by a second allocati on ratio of the edge sharpness factor, and for summing both the multiplied values to determine the correction interpolation pixel value.

19. The apparatus of claim 18, wherein the pixel value selection unit selects a greatest pixel value from among the adjacent pixel values as the first selection value, and selects a smallest pixel value from among the adjacent pixel values as the second selection value.

20. The apparatus of claim 19, wherein the threshold value decision unit comprises:
an operation value detector for selecting as a specific operation value, a value equal to or smaller than 1 from among values created by substituting the horizontal distance and the vertical distance of the edge correction operation value into the denominator and the numerator, and into the numerator and the denominator, respectively;
a selection value average detector for obtaining an average between the first selection value and the second selection value as a selection value average; and
a threshold value operation unit for selecting the threshold value using the specific operation value and the selection value average.

21. The apparatus of claim 20, wherein the threshold value is obtained according to the following equation:
Th=M+Fc*S*(E−M), wherein Th is the threshold value, M is the selection value average, Fc is the edge correction factor, S is the specific operation value and E is the specific adjacent pixel value.

22. The apparatus of claim 20, wherein the selection value decision unit selects the first selection value if the first pixel value is greater than the threshold value, and selects the second selection value if the first pixel value is equal to or smaller than the threshold value.

23. The apparatus of claim 22, wherein the correction pixel value detector selects a value obtained by dividing a difference between the specific adjacent pixel value of the specific adjacent pixel and the first pixel value, by a distance between the specific adjacent pixel and the corresponding location, as the first allocation ratio of the edge sharpness factor.

24. The apparatus of claim 14, further comprising a correction interpolation request sensor for determining whether digital image interpolation for edge correction is required.

25. The apparatus of claim 24, wherein the correction interpolation request sensor comprises:
an average pixel value detector for calculating an average pixel value of the adjacent pixel values;
a level average detector for dividing the adjacent pixel values into two groups according to the average pixel value and selecting averages of pixel values in each of the groups as a high level average and a low level average;
an average difference value detector for obtaining an average difference value between the high level average and the low level average; and
a comparator for comparing the average difference value with a predetermined reference value.

26. The apparatus of claim 14, further comprising,
an emphasis pixel value detector for calculating an emphasis pixel value for emphasizing a contrast of an edge pixel in an edge of the magnified image using the correction interpolation pixel value, a second pixel value obtained by the second interpolation, and an edge image quality enhancement factor for edge image quality enhancement.

27. The apparatus of claim 26, wherein the emphasis pixel value detector obtains the emphasis pixel value using the following equation:
R=Q+Fe*(Q−P),
wherein R is the emphasis pixel value, Q is the correction interpolation pixel value, Fe is the edge image quality enhancement factor, and P is the second pixel value.
